(19) United States
(12) Patent Application Publication
(10) Pub. No.: US 2026/0165535 A1
(43) Pub. Date: Jun. 18, 2026

(54) SMALL DOMESTIC APPLIANCE

(71) Applicant: BSH Hausgeräte GmbH, Munich (DE)

(72) Inventors: Jesus Manuel Moya Nogues, Zaragoza (ES); Sergio Llorente Gil, Zaragoza (ES); Jorge Pascual Aza, Zaragoza (ES); Javier Serrano Trullen, Zaragoza (ES); Jorge Tesa Betes, Zaragoza (ES)

(21) Appl. No.: 18/711,906

(22) PCT Filed: Dec. 1, 2022
(86) PCT No.: PCT/EP2022/084084

§ 371 Date: May 21, 2024

(30) Foreign Application Priority Data
Dec. 3, 2021 (EP) 21383109.2

(51) Int. Cl. A47J 43/07; A23L 5/10; A47J 27/00; A47J 36/32; A47J 43/044; H05B 6/02

(52) U.S. Cl. CPC A47J 43/0705; A23L 5/15; A47J 27/004; A47J 36/32; A47J 43/044; H05B 6/02; A47J 2043/04454

(57) ABSTRACT

A small household appliance includes a functional unit designed to provide a household appliance function, an inductive intake element designed to receive energy inductively and to supply energy to the functional unit using the inductively received energy, and an energy store designed to store the inductively received energy.

The invention relates to a small household appliance as claimed in the preamble of claim 1, a household appliance system as claimed in claim 10 and a method for operating a small household appliance as claimed in the preamble of claim 13.

Small household appliances, which have at least one functional unit for providing a household appliance function, for example a stirring unit, are already known from the prior art. Many small household appliances can be connected to the power supply network by way of a cable to supply energy to the functional unit. Modern small household appliances also have an inductive intake element for receiving energy inductively, for example through an induction coil of an induction cooktop. However in both instances there is disadvantageously very little flexibility for a user, as the functional unit can only be operated in proximity to a power outlet and/or in proximity to an induction coil inductively providing the energy required to supply energy to the functional unit.

The object of the invention is in particular, although not solely, to provide a generic device with improved properties in respect of flexibility. According to the invention the object is achieved by the features of claim 1, while advantageous embodiments and developments of the invention will emerge from the subclaims.

The invention is based on a small household appliance, having a functional unit for providing at least one household appliance function and having an inductive intake element for receiving energy inductively and for supplying energy to the functional unit using the inductively received energy.

It is proposed that the small household appliance has at least one energy store for storing the inductively received energy.

Such an embodiment advantageously results in a small household appliance with a particularly high level of flexibility, as operation of the functional unit is made possible regardless of the current location of the small household appliance. A high level of convenience is also possible. In contrast to small household appliances, for example temperature sensors, which are operated using single-use batteries, it is advantageously also possible to save resources and reduce waste. It allows a particularly sustainable and/or environmentally friendly small household appliance to be provided.

The small household appliance is a freely locatable household appliance, which contains at least the small household appliance device and can also contain further assemblies and/or units and/or elements, which are not part of the small household appliance device. “Freely locatable” here means that the small household appliance can be placed anywhere, and in particular without aids, by a user in a household setting, in particular in contrast to a large household appliance, which is positioned and/or installed permanently in a specific position in a household setting, for example an oven or a refrigerator or a cooktop. The small household appliance is preferably configured as a small kitchen appliance and in an operating state provides at least one household appliance function for processing food. The small household appliance could be configured but is not restricted to being configured for example as a multifunctional food processor and/or a mixer and/or a stirrer and/or a grinder and/or kitchen scales or as a kettle or coffee machine or a rice cooker or milk frother or fryer, in particular an air fryer, or a toaster or juicer or a slicing machine or a temperature gauge. The small household appliance can also be for example a cooking utensil with at least one electrically operated additional function, in particular a pot or skillet with an integrated temperature sensor or the like.

The inductive intake element comprises at least one secondary coil and/or is configured as a secondary coil. When coupled to an inductive supply element, which supplies energy inductively to the inductive intake element, the inductive intake element supplies electrical energy to the functional unit and/or the energy store.

When the small household appliance is in an operating state, the functional unit provides at least one small household appliance function. Depending on the nature of the small household appliance, the small household appliance function can be, but is not restricted to, one of various functions, for example a cooking function and/or a boiling function and/or a baking function and/or a warming function and/or a keeping warm function and/or a stirring function and/or a sensor function and/or a frying function and/or a mixer function and/or a chopping function and/or a slicing function and/or a grinding function and/or the like.

The energy store is provided to store electrical energy in a charge state and to supply energy to the functional unit in a discharge state. The energy store could be connected directly to the functional unit. It is also conceivable for the energy store to be connected to the functional unit indirectly by way of at least one further unit of the small household appliance, for example by way of a control unit. The energy store could be configured as a lithium ion battery based on lithium cobalt (III) oxide (LiCoO₂) and have at least one positive electrode made of LiCoO₂ and at least one negative electrode made of graphite with stored lithium. The energy store is preferably configured as a battery and has at least one positive electrode made of lithium iron phosphate (LiFEPO₄) and/or nickel (II) hydroxide and at least one negative electrode made of graphite with stored lithium and/or a metal hydride. The energy store can be configured as a lithium iron phosphate battery or a nickel metal hydride battery for example. The small household appliance could contain precisely one energy store. Alternatively the small household appliance could also contain multiple energy stores. In the case of a small household appliance containing multiple energy stores the energy stores could be connected electrically parallel and/or electrically in series to one another and be provided for the simultaneous supply of energy to the functional unit. In the case of a small household appliance containing multiple energy stores it is alternatively or additionally also conceivable for at least a first energy store to be provided to supply energy for the operation of a first functional sub-unit and/or a first functional element of the functional unit and at least a second energy store to be provided to supply energy for the operation of a second functional sub-unit and/or a second functional element of the functional unit. In the case of a small household appliance containing multiple energy stores it is also conceivable for at least a first energy store to be provided to supply energy to the functional unit over a first time period and at least a second energy store to be provided to supply energy to the functional unit over a second time period. In the case of a small household appliance containing multiple energy stores all the energy stores can be configured identically, for example as batteries of the same type, of the same shape and size and with the same characteristic values, for example power, nominal voltage and the like. It would also be conceivable for at least two energy stores of the small household appliance to be different in respect of type and/or shape and/or size and/or at least one characteristic value.

In the present document numerical words, such as “first” and “second” preceding specific terms are only used to differentiate objects and/or to assign between objects and do not imply any total number and/or ranking of the objects. In particular a “second object” does not necessarily imply the presence of a “first object”.

“Provided” means specifically programmed, designed and/or equipped. That an object is provided for a specific function means in particular that the object performs and/or executes said specific function in a least one application and/or operating state.

It is further proposed that the small household appliance has a control unit for switching between at least one main operating mode and at least one secondary operating mode. Such an embodiment advantageously increases flexibility further. It can result in particular in a small household appliance with a broad functional spectrum. A “control unit” refers to an electronic unit, which is provided to provide closed-loop and/or open-loop control of at least one unit, in particular at least the functional unit, of the small household appliance. The control unit preferably comprises a computation unit and, in particular in addition to the computation unit, at least one storage unit, which provides at least one temporary working store for the computation unit. The control unit can be provided to provide closed-loop and/or open-loop control of multiple units of the small household appliance, for example the functional unit and an output unit and/or a communication unit. An “operating mode” refers to an operating state, in which the functional unit provides at least one household appliance function. In main operating mode the functional unit provides at least one household appliance main function. In secondary operating mode the functional unit provides at least one household appliance secondary function. In main operating mode the functional unit can provide at least one household appliance secondary function in addition to the at least one household appliance main function. Main operating mode differs from secondary operating mode at least in respect of the energy requirement of the functional unit. The energy requirement of the functional unit in main operating mode is at least 50% greater than an energy requirement of the functional unit in secondary operating mode. The functional unit has at least a first functional sub-unit, which is provided to provide the at least one household appliance main function. The functional unit has at least a second functional sub-unit, which is provided to provide the at least one household appliance secondary function.

It is also proposed that the control unit switches from main operating mode to secondary operating mode when energy is supplied by way of the energy store. This can advantageously improve convenience. The control unit is preferably provided to switch the supply of energy to the functional unit from the inductive intake element to the energy store when the inductive intake of energy by the inductive intake unit is interrupted, for example when an inductive supply element is disconnected or the small household appliance is raised from a placement plate, below which the inductive supply element is arranged. The control unit preferably has at least one switching unit with at least one switching element. The switching element could be configured as a mechanical and/or electromechanical switching element, for example a relay. Alternatively the switching element could be configured as a semiconductor switching element, in particular as a transistor, for example a FET and/or MOSFET and/or IGBT. The switching unit is provided to establish and break electrically conducting connections between the inductive intake element and the first functional sub-unit and/or the second functional sub-unit and/or further functional sub-units of the functional unit. The switching unit is also provided to establish and break electrically conducting connections between the energy store and the inductive intake element and/or the first functional sub-unit and/or the second functional sub-unit and/or further functional sub-units of the functional unit. The switching unit can have at least one switching element, which is configured as a toggle switch, for example a single pole double throw switch (SPDT) or a double pole double throw switch (DPDT) and is provided to establish at least a first electrically conducting connection and at the same time to break at least a second electrically conducting connection. It would be conceivable for example for the control unit, when the inductive intake of energy by the inductive intake unit is interrupted, to switch the switching element of the switching unit configured as a toggle switch so that an electrically conducting connection between the inductive intake element and the first functional sub-unit of the functional unit is broken and at the same time an electrically conducting connection between the energy store and the second functional sub-unit of the functional unit is established.

It is further proposed that the main operating mode comprises at least one stirring function. This can advantageously result in a household appliance with improved operating convenience. The first functional sub-unit of the functional unit is preferably configured as a stirring unit to provide the stirring function. Alternatively or additionally it is proposed that the main operating mode comprises at least one cooking function. Such an embodiment advantageously can further improve operating convenience. A further first functional sub-unit of the functional unit is preferably configured as a heating unit to provide the cooking function. Depending on the nature of the household appliance, the main operating mode can alternatively or additionally comprise further household appliance main functions, for example a baking function and/or a warming function and/or a frying function and/or a mixer function and/or a chopping function and/or a slicing function and/or a grinding function and/or the like, the functional unit having correspondingly configured functional sub-units.

It is further proposed that the secondary operating mode comprises at least one keeping warm function. Such an embodiment can further improve convenience. The second functional sub-unit of the functional unit is preferably configured as a heating unit to provide the keeping warm function. Depending on the nature of the household appliance, the secondary operating mode can alternatively or additionally comprise further household appliance secondary functions, for example sensor functions and/or timer functions and/or the like, the functional unit having correspondingly configured functional sub-units.

The energy store could be provided to supply energy to the functional unit in main operating mode. In one advantageous embodiment however it is proposed that the energy store is provided to supply energy to the functional unit in secondary operating mode. Such an embodiment can advantageously improve efficiency. A particularly low-weight, compact energy store can advantageously be used.

It is further proposed that a maximum electric power in secondary operating mode is maximum 25% of a maximum electric power in main operating mode. Such an embodiment can advantageously further improve efficiency. In particular a low-weight, compact energy store can be used, when the energy store is provided to supply energy to the functional unit in secondary operating mode and the maximum electric power in secondary operating mode is maximum 25% of the maximum electric power in main operating mode. The power in secondary operating mode is in particular maximum 20%, advantageously maximum 15%, particularly advantageously maximum 10%, preferably maximum 7.5% and particularly preferably maximum 5% of the maximum power in main operating mode. For example the maximum electric power of the functional unit in main operating mode could be 2,200 Watt and the maximum electric power of the functional unit in secondary operating mode could be 100 Watt.

The energy store could be permanently integrated in the small household appliance. In one advantageous embodiment it is proposed however that the energy store can be removed. This can advantageously improve convenience. It advantageously allows easy replacement of the energy store, for example in the event of a fault. The energy store can preferably be removed without tools. The energy store could be connected to the small household appliance for example by means of a form-fit and/or force-fit connection, for example a latching connection or the like, so that it can be removed by detaching the form-fit and/or force-fit connection, in particular without tools. The small household appliance could comprise at least one further energy store, which can be connected to the small household appliance, in particular by means of a form-fit and/or force-fit, after removal of the energy store from the small household appliance. The energy store and the further energy store could be configured substantially identically to one another, it being possible for the further energy store to be provided as a replacement for the energy store. It is also conceivable for the energy store and the further energy store to differ from one another in respect of at least one characteristic value. For example the energy store and the further energy store could have different storage capacities and/or powers and/or nominal voltages and/or the like. For example the energy store could be provided to supply energy to the functional unit in a first operating mode, for example in secondary operating mode, and the further energy store could be provided to supply energy to the functional unit in a second operating mode, for example in main operating mode.

The invention further relates to a household appliance system having at least one small household appliance according to one of the embodiments described above, with a placement plate and with a supply unit arranged below the placement plate, which has at least one inductive supply element for providing energy inductively for the inductive intake element. Such a household appliance system is characterized in particular by its advantageous properties in respect of flexibility and operating convenience. A “placement plate” refers to at least one, in particular plate-type, unit, which is provided to hold at least one small household appliance and/or a cooking utensil and/or at least one item to be cooked. The placement plate could be configured for example as a worktop, in particular a kitchen worktop, or as a sub-region of at least one worktop, in particular at least one kitchen worktop, in particular of the household appliance system. Alternatively or additionally the placement plate could be configured as a cooktop plate. The placement plate configured as a cooktop plate could in particular form at least part of a cooktop outer housing and in particular at least largely form the cooktop outer housing together with at least one outer housing unit, to which the placement plate configured as a cooktop plate could be connected in particular in at least one assembled state. The placement plate is preferably made of a non-metallic material. The placement plate could be made for example at least largely of glass and/or glass ceramic and/or Neolith and/or Dekton and/or wood and/or marble and/or stone, in particular natural stone, and or/laminate and/or plastic and/or ceramic. A “supply unit” refers in particular to a unit, which provides energy inductively in at least one operating state and which in particular has a main functionality in the form of energy provision. To provide energy the supply unit has at least one inductive supply element, which has at least one coil, in particular at least one primary coil, and/or is configured as a coil and which provides energy inductively in particular in the operating state. The supply unit could have at least two, in particular at least three, advantageously at least four, particularly advantageously at least five, preferably at least eight and particularly preferably multiple inductive supply elements, which could each provide energy inductively in the operating state, in particular to a single inductive intake element or to at least two or multiple inductive intake elements of at least one small household appliance and/or at least one further small household appliance. At least some of the inductive supply elements could be arranged in proximity to one another, for example in a row and/or in the form of a matrix. The supply unit has at least one inverter unit for operating at least one inductive supply element. In the operating state the inverter unit preferably performs a frequency conversion and in particular converts an input-side low-frequency AC voltage, in particular a grid AC voltage of a power supply network, to an output-side high-frequency AC voltage. The low-frequency AC voltage preferably has a frequency of maximum 100 Hz. The high-frequency AC voltage preferably has a frequency of at least 1000 Hz. The inverter unit is preferably provided to adjust the energy provided inductively by the at least one inductive supply element by adjusting the high-frequency AC voltage. The supply unit preferably comprises at least one rectifier. The rectifier is provided to rectify the input-side low-frequency AC voltage, in particular the grid AC voltage of a power supply network, in particular to a rectified grid AC voltage. The inverter unit has at least one inverter switching element. The inverter switching element preferably generates an oscillating electric alternating current, preferably with a frequency of at least 15 kHz, in particular at least 17 kHz and advantageously at least 20 kHz, to operate the at least one inductive supply element. The inverter unit preferably comprises at least two inverter switching elements, which are preferably configured as bipolar transistors with an insulated gate electrode. The inverter unit preferably comprises at least one damping capacitor. The frequency of the oscillating electric alternating current generated by the inverter switching element in the operating state preferably corresponds at least substantially, preferably exactly, to a switching frequency of the inverter switching element.

It is also proposed that the household appliance system comprises at least one further small household appliance, which has at least one further inductive intake element for receiving the inductively provided energy. This advantageously results in a household appliance system with a particularly broad functional spectrum. The small household appliance and the further small household appliance could be configured at least substantially identically to one another. However the further small household appliance preferably has a further functional unit, which differs from the functional unit of the small household appliance in respect of at least one deliverable household appliance function. For example the small household appliance could be configured as a multifunctional food processor and the further small household appliance as a fryer. The household appliance system can also have one or multiple further small household appliances. The further small household appliance can contain a further energy store for storing the inductively received energy.

It is further proposed that the small household appliance has a removable energy store and the energy store can be used in the further small household appliance. Such an embodiment can advantageously improve flexibility and operating convenience still further. Efficiency can also advantageously be improved and resources saved, for example because the household appliance system contains precisely one energy store, which can be used as required with the small household appliance or the further small household appliance. It is conceivable for example for the functional unit of the small household appliance to be operated in main operating mode, being supplied inductively in the process by way of the inductive intake element with the energy provided by the inductive supply element, the further functional unit of the further small household appliance being operated in particular in secondary operating mode and being supplied with energy by the energy store in the process. It is also conceivable for the household appliance system to comprise multiple energy stores, each of which can be used as required with the small household appliance or the further small household appliance.

The invention is also based on a method for operating a small household appliance, in particular according to one of the embodiments described above, having a functional unit for providing at least one household appliance function, and having an inductive intake element for receiving energy inductively and for supplying the functional unit with the inductively received energy.

It is proposed that an energy store of the small household appliance is charged by way of the energy received inductively by means of the inductive intake element. This advantageously provides a method for particularly flexible and convenient operation of the small household appliance.

The small household appliance and the household appliance system here should not be restricted to the application and embodiment described above. In particular, to comply with a mode of operation described herein, the small household appliance and/or the household appliance system can have a different number of individual elements, parts and units from the number cited herein.

Further advantages will emerge from the description of the drawing which follows. The drawing shows an exemplary embodiment of the invention. The drawing, description and claims contain numerous features in combination. The person skilled in the art will expediently also consider the features individually and combine them in useful further combinations.

In the drawing:

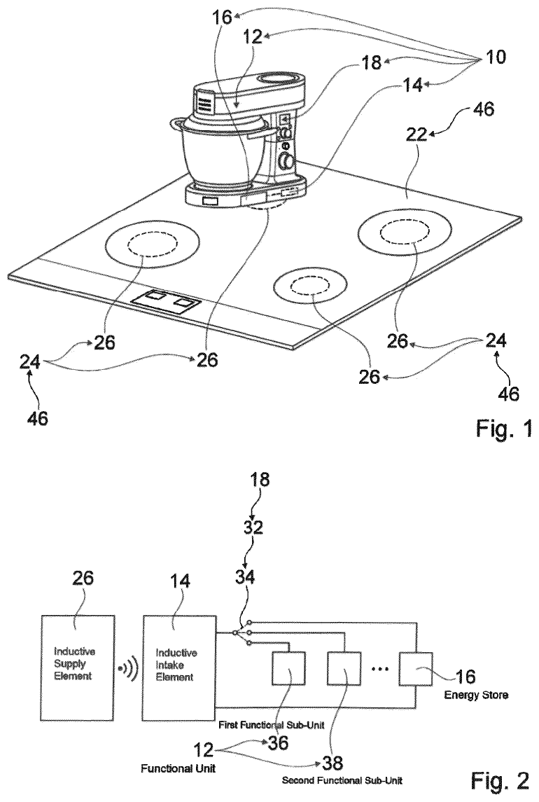

FIG. 1 shows a schematic diagram of a small household appliance, which is positioned on a placement plate and has a functional unit, a control unit, an inductive intake element for receiving energy inductively and an energy store for storing the inductively received energy,

FIG. 2 shows a schematic circuit diagram illustrating a mode of operation of the control unit of the small household appliance,

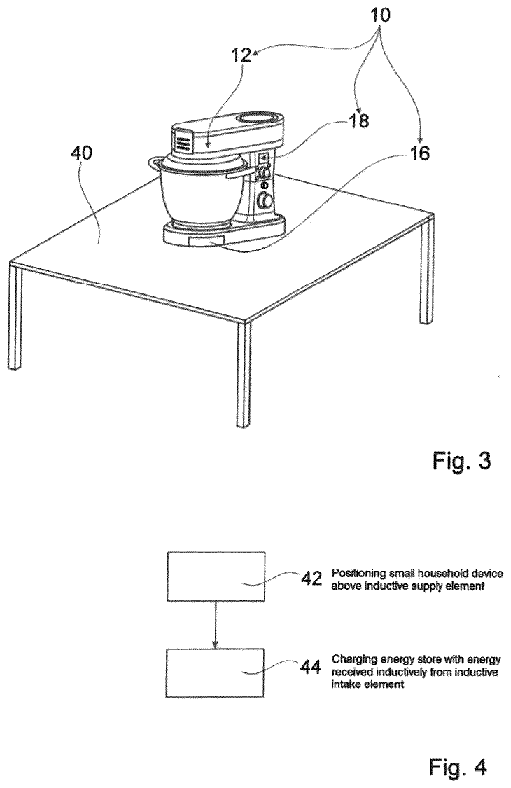

FIG. 3 shows a schematic diagram of the small household appliance positioned on a table to demonstrate a secondary operating mode of the functional unit,

FIG. 4 shows a schematic flow diagram to illustrate a method for operating the small household appliance, and

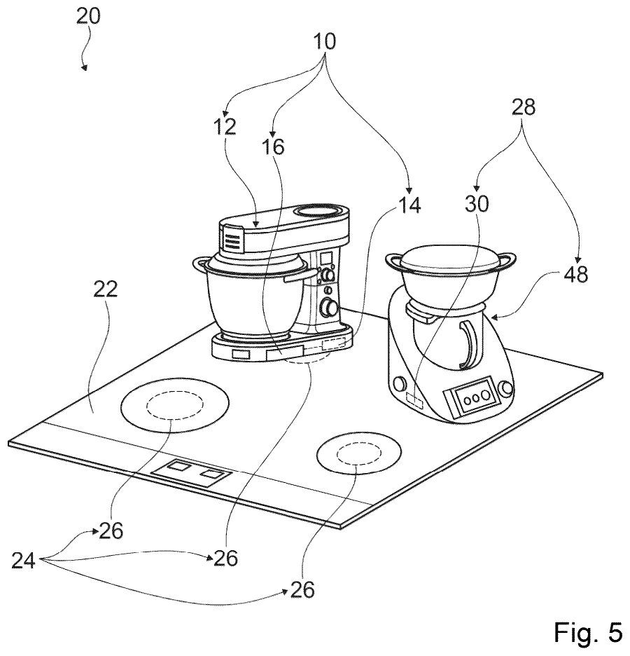

FIG. 5 shows a schematic diagram of a household appliance system with the placement plate, a supply unit arranged below the placement plate, the small household appliance and a further small household appliance.

FIG. 1 shows a schematic diagram of a small household appliance 10. The small household appliance 10 has at least one functional unit 12. The functional unit 12 is provided to provide at least one household appliance function. In the present exemplary embodiment the small household appliance 10 is configured as a multifunctional food processor. The functional unit 12 of the small household appliance 10 is provided to provide multiple different household appliance functions.

The small household appliance 10 has an inductive intake element 14. The inductive intake element 14 is provide to receive energy inductively.

The small household appliance 10 is positioned on a placement plate 22 in FIG. 1. Below the placement plate 10 is a supply unit 24 with at least one inductive supply element 26 for providing energy inductively for the inductive intake element 14. The placement plate 22 and the supply unit 24 are part of an induction cooktop 46 in the present exemplary embodiment.

The small household appliance 10 contains an energy store 16. The energy store 16 is provided to store the inductively received energy. The energy store 16 here is configured as a battery, specifically a lithium ion battery.

The small household appliance 10 has a control unit 18. The control unit 18 is provided to control the functional unit 12. The control unit 18 is provided to switch between at least one main operating mode of the functional unit 12 and at least one secondary operating mode of the functional unit 12.

The main operating mode comprises at least one stirring function. The main operating mode also comprises at least one cooking function. The main operating mode can also comprise further household appliance functions of the functional unit 12. The secondary operating mode comprises at least one keeping warm function.

The energy store 16 here is provided to supply energy to the functional unit 12 in secondary operating mode.

In secondary operating mode a maximum electric power of the functional unit 12 is maximum 25% of a maximum electric power of the functional unit 12 in main operating mode. In main operating mode the maximum electric power of the functional unit 12 can be for example 2,200 Watt, when the cooking function and stirring function are provided at the same time. In secondary operating mode the maximum electric power of the functional unit 12 can be for example 100 Watt when the keeping warm function is provided.

FIG. 2 shows a schematic circuit diagram to illustrate a mode of operation of the control unit 18 of the small household appliance 10. The control unit 18 has at least one switching unit 32 with at least one switching element 34. The switching unit 32 is provided to allow the control unit 18 to switch between the main operating mode and the secondary operating mode of the functional unit 12.

The functional unit 12 has at least a first functional sub-unit 36 to provide the at least one household appliance function, specifically a household appliance main function in main operating mode. The first functional sub-unit 36 can be for example a stirring unit for providing the stirring function or a heating unit for providing the cooking function.

The functional unit 12 also has at least a second functional sub-unit 38 to provide the at least one household appliance function, specifically a household appliance secondary function in secondary operating mode. The second functional sub-unit 38 can comprise for example a heating element for providing the keeping warm function.

In a first state, in which the small household appliance 10 is positioned on the placement plate 22 and the inductive intake element 14 receives the energy provided inductively by the inductive supply element 26 (see FIG. 1), the control unit 18 connects the first functional sub-unit 36 and/or the second functional sub-unit 38 to the inductive intake element 14.

In a second state, in which the small household appliance 10 is not positioned on the placement plate 22 and the inductive intake element 14 does not receive energy inductively, the control unit 18 connects the second functional sub-unit 38 to the energy store 16.

The control unit 18 switches from main operating mode to secondary operating mode, when energy is supplied by way of the energy store 16. To this end the control unit 18 uses the switching unit 32 to break the connection between the inductive intake element 14 and the first functional sub-unit 36 and/or the second functional sub-unit 38 and to connect the second functional sub-unit 38 to the energy store 16.

FIG. 3 shows a schematic diagram of the small household appliance 10. In FIG. 3 the small household appliance 10 is positioned on a table 40. The inductive intake element 14 therefore receives no energy and the functional unit 12 is supplied with energy by way of the energy store 16. In this state the functional unit 12 is operated in secondary operating mode. A user of the small household appliance 10 can for example keep food, which they prepared beforehand by means of the functional unit 12 in main operating mode, warm by means of the keeping warm function in secondary operating mode. The small household appliance 10 does not have to be positioned above the placement plate 22 of the induction cooktop 46 for this (see FIG. 1). For example the induction cooktop 46 could be located in a kitchen and the table 40 in a dining room, so that food, which has been prepared by means of a household appliance main function of the functional unit 12, for example the cooking function and/or the stirring function, when the household appliance 10 was positioned on the placement plate 22 of the induction cooktop 46 and the functional unit 12 was supplied directly using the energy received inductively by the inductive intake unit 14, can then be transported onto the table 40 together with the small household appliance 10 and kept warm there with the functional unit 12 in secondary operating mode, it being possible for the functional unit 12 to be supplied with energy by the energy store 16 in the process.

FIG. 4 shows a schematic flow diagram of a method for operating the small household appliance 10. In the method the energy store 16 of the small household appliance 10 is charged by way of the energy received inductively by means of the inductive intake element 14. The method comprises at least two method steps 42, 44. In a first method step 42 of the method the small household appliance 10 is positioned above an inductive supply element 26, so that the inductive intake element 14 couples inductively to the inductive supply element 26. In a second method step 44 of the method the inductive supply element 26 provides energy inductively for the inductive intake element 14, the energy store 16 being charged by way of the energy received inductively by means of the inductive intake element 14 in the process.

FIG. 5 shows a schematic diagram of a household appliance system 20. The household appliance system 20 comprises the small household appliance 10 as well as the placement plate 22 and the supply unit 24 arranged below the placement plate 22, with the at least one inductive supply element 26 for providing energy inductively.

The household appliance system 20 also comprises at least one further small household appliance 28. The further small household appliance 28 has at least one further functional unit 48. The further functional unit 48 is provided to provide at least one household appliance function. In the present exemplary embodiment the further small household appliance 28 is configured as a fryer, specifically an air fryer. In a main operating mode the further functional unit 48 provides at least one frying function. In a secondary operating mode the further functional unit 48 provides at least one keeping warm function.

The further small household appliance 28 has a further inductive intake element 30 for receiving the inductively provided energy.

The removable energy store 16 of the small household appliance 10 can be used in the further small household appliance 28. For this the further small household appliance has a holding element (not shown) on the rear of the appliance. When the household appliance system 20 is in an operating state, the small household appliance 10 can be operated for example with the functional unit 12 in main operating mode and/or secondary operating mode, when the small household appliance 10 is positioned on the placement plate 22 and the functional unit 12 is supplied with energy received inductively from the inductive supply element 26 by means of the inductive intake element 14. At the same time, when the household appliance system 20 is in the operating state, the further small household appliance 28 for example can be operated with the further functional unit 48 in secondary operating mode, when the energy store 16 is connected to the further small household appliance 28 to supply the further functional unit 48. The further small household appliance 28 does not have to be positioned on the placement plate 22 for this.

Reference characters

| | |
|---|---|
| 10 | Small household appliance |
| 12 | Functional unit |
| 14 | Inductive intake element |
| 16 | Energy store |
| 18 | Control unit |
| 20 | Household appliance system |
| 22 | Placement plate |
| 24 | Supply unit |
| 26 | Inductive supply element |
| 28 | Further small household appliance |
| 30 | Further inductive intake element |
| 32 | Switching unit |
| 34 | Switching element |
| 36 | First functional sub-unit |
| 38 | Second functional sub-unit |
| 40 | Table |
| 42 | First method step |
| 44 | Second method step |
| 46 | Induction cooktop |
| 48 | Further functional unit |

1.-13. (canceled)

14. A small household appliance, comprising:
a functional unit designed to provide a household appliance function;
an inductive intake element designed to receive energy inductively and to supply energy to the functional unit using the inductively received energy; and
an energy store designed to store the inductively received energy.

15. The small household appliance of claim 14, further comprising a control unit designed to switch between a main operating mode and a secondary operating mode.

16. The small household appliance of claim 15, wherein the control unit switches from the main operating mode to the secondary operating mode when energy is supplied by way of the energy store.

17. The small household appliance of claim 15, wherein the main operating mode comprises a stirring function.

18. The small household appliance of claim 15, wherein the main operating mode comprises a cooking function.

19. The small household appliance of claim 15, wherein the secondary operating mode comprises a keeping warm function.

20. The small household appliance of claim 15, wherein the energy store is designed to supply energy to the functional unit in the secondary operating mode.

21. The small household appliance of claim 15, wherein a maximum electric power in the secondary operating mode is maximum 25% of a maximum electric power in the main operating mode.

22. The small household appliance of claim 14, wherein the energy store is designed to enable removal thereof.

23. A household appliance system, comprising:
a small household appliance comprising a functional unit designed to provide a household appliance function, an inductive intake element designed to receive energy inductively and to supply energy to the functional unit using the inductively received energy, and an energy store designed to store the inductively received energy;
a placement plate; and
a supply unit arranged below the placement plate and comprising an inductive supply element for providing energy inductively for the inductive intake element.

24. The household appliance system of claim 23, further comprising a further said small household appliance comprising a further inductive intake element for receiving the inductively provided energy.

25. The household appliance system of claim 23, wherein the energy store of the small household appliance is designed to enable removal thereof.

26. The household appliance of claim 25, wherein the energy store is designed for use in the further small household appliance.

27. A method for operating a small household appliance, the method comprising:
providing energy inductively to an inductive intake element;
charging an energy store of the small household appliance by the energy received inductively from the inductive intake element; and
supplying the inductively provided energy to a functional unit of the small household appliance for providing a household appliance function.

28. The method of claim 27, further comprising switching with a control unit between a main operating mode and a secondary operating mode.

29. The method of claim 28, wherein the control unit switches from the main operating mode to the secondary operating mode when energy is supplied by way of the energy store.

30. The method of claim 28, wherein the main operating mode comprises at least one of a stirring function or a cooking function, and wherein the secondary operating mode comprises a keeping warm function.

31. The method of claim 28, wherein the energy store supplies energy to the functional unit in the secondary operating mode.

32. The method of claim 28, wherein a maximum electric power in the secondary operating mode is maximum 25% of a maximum electric power in the main operating mode.

33. The method of claim 27, further comprising designing the energy store to enable removal thereof.
